(19) United States
(12) Patent Application Publication
(10) Pub. No.: US 2014/0279054 A1
(43) Pub. Date: Sep. 18, 2014

(54) AUCTIONING IN-MAP AD PLACEMENT

(71) Applicant: Google Inc., (US)

(72) Inventors: Alexander FABRIKANT, Palo Alto, CA (US); Daniel Wyatt, San Francisco, CA (US)

(73) Assignee: Google Inc., Mountain View, CA (US)

(21) Appl. No.: 13/840,907

(22) Filed: Mar. 15, 2013

(51) Int. Cl. G06Q 30/02

(52) U.S. Cl. CPC G06Q 30/0275
USPC 705/14.71

(57) ABSTRACT

A system and machine-implemented method is provided for multi-party auctioning of map content, the method including identifying a first region on a map, determining one or more special bids for one or more map features associated with a location within the first region, determining one or more bids for one or more contents to be placed on the first region, the one or more contents comprising one or more of one or more advertisements or one or more map features, selecting a set of content to be displayed on the first region of the map based at least in part on the one or more special bids and one or more bids, the set of content including one or more of one or more advertisements or one or more map features and rendering the first region of the map including the set of content.

### BACKGROUND

Users are relying on maps served online more and more every day. For example, users use online maps for information related to directions, locations, business, attractions, events, and other entities. In some cases, there is an opportunity to provide a user with such information and search results, while providing a service to the businesses that are the objects of the search, and monetizing the usage of these maps and related services. When monetizing map usage (e.g., through advertisement or third party APIs) several aspects of advertisement and content placement must be taken into account. For the purpose of map monetization, there are three parties whose needs may need to be addressed. These parties include the provider of the maps (e.g., the party who maintains map data and generates maps), the third parties serving the maps (e.g., using third party APIs), and the advertisers who will pay for ad space on these maps. Techniques described herein take the needs of these parties into consideration.

### SUMMARY

The disclosed subject matter relates to a computer-implemented method for multi-party auctioning of map content, the method comprising identifying, using one or more computing devices, a first region on a map. The method may further include determining, using the one or more computing devices, one or more special bids for one or more map features associated with a location within the first region. The method may further include determining, using the one or more computing devices, one or more bids for one or more contents to be placed on the first region, the one or more contents comprising one or more of one or more advertisements or one or more map features. The method may further include selecting, using the one or more computing devices, a set of content to be displayed on the first region of the map based at least in part on the one or more special bids and one or more bids, the set of content including one or more of one or more advertisements or one or more map features and rendering, using the one or more computing devices, the first region of the map including the set of content.

The disclosed subject matter also relates to a system for multi-party auctioning of map content, the system comprising one or more processors and a machine-readable medium comprising instructions stored therein, which when executed by the processors, cause the processors to perform operations comprising identifying a first region on a map, the first region of the map corresponding to an area within a map being displayed at a first zoom level. The operations may further include determining one or more special bids for one or more map features being located within the first region of the map. The operations may further include determining one or more bids for one or more commercial contents to be displayed on the first region. The operations may further include selecting one or more contents for display within the first region of the map based at least in part on the one or more special bids and one or more bids, the one or more contents including one or more of map features or commercial content and rendering, using the one or more computing devices, the first region of the map including the one or more contents.

The disclosed subject matter also relates to a machine-readable medium comprising instructions stored therein, which when executed by a machine, cause the machine to perform operations comprising identifying a map region, the map region being displayable at a plurality of zoom levels. The operations may further include determining one or more bids for one or more map features to be displayed within the map region at one or more of the plurality of zoom levels, the value of the one or more bids for the one or more map features at each of the one or more zoom levels indicating the importance of a map feature being displayed within the map region at the zoom level. The operations may further include determining one or more bids for one or more commercial contents to be displayed within the map region at one or more of the plurality of zoom levels and determining one or more of the map features or the one or more commercial contents to be displayed within the map region at each of the plurality of zoom levels based at least in part on the one or more bids for the one or more map features and the one or more bids for the one or more commercial contents.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment which provides for auctioning space in maps for the display of map features as well as commercial data.

FIG. 2 illustrates a flow diagram of an example process for generating a map region based on an auction for content to be displayed within the map.

FIG. 3 illustrates a flow diagram of an example process for providing a map to a third party.

FIG. 4 illustrates an example user interface provided for display to a provider or third party server to facilitate placing bids on map features.

FIG. 5 illustrates an example user interface provided for display to an advertiser to facilitate placing bids for displaying an ad within a map region.

FIG. 6 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

I. Overview

It would be beneficial to provide a scheme for auctioning blank space in maps for the display of commercial data (“ad”) (e.g., textual or visual ads), as well as a method for pricing served maps to allow the third parties to share in ad revenue and buy access to varying types of map products with varying levels of ad presence, to better balance the revenue generated from advertisement inserted into served map data and the needs and preferences of third parties purchasing map data as to the amount of advertisements they wish to have included in the map data.

The subject disclosure provides a method and system for facilitating a scheme for auctioning space in maps for the display of map data as well as commercial data (“ad”) (e.g., textual or visual ads). The scheme further facilitates a technique for pricing served maps to allow third parties map providers to share in ad revenue and buy access to varying amounts of ad-free map space. The system and method provided herein provide a bidding infrastructure where multiple parties can bid on content that may appear on a map region (e.g., a location on a map at a specific zoom level), where that content may be map content or ads.

In one implementation, advertisers can bid on placing an ad (text or visual) somewhere within some region of a map (e.g., as defined by a rectangle or a polygon), and may select which map zoom levels the ad will be displayed at. In addition to the advertiser, the map content provider providing the map data to generate the map (“provider”) can place “special bids” (similar to auction reserve prices) on visible map areas (e.g., a region defined as a portion of a map at a specific zoom level).

In some implementations, the multi-party bidding infrastructure allows for balancing of the value of map data against the revenue derived from advertisement being placed on the map. For example, in truly empty spaces (e.g. in the middle of tundra), any interested advertiser would have no competition with the provider. On the other hand, in heavily populated spaces (e.g., a major metropolitan city), the provider would create lots of competition by placing special bids on map data including the relevant ground-truth labels and map features within the space.

When placing special bids, the provider can bid arbitrarily high for certain types of map features to prevent advertisements from covering them. The maps features may be organic map content needed to preserve “ground truth” labels that come from objective map data and/or the provider considers important enough to not be omitted in favor of an advertisement.

The special bids placed by the provider for map data within a map region may be based on a number of factors. These factors may be similar to factors used to decide whether to show a label in a dynamic online map. Such factors may include zoom level, for example, country names should have very high special bids for a world-scale map, but zeroed out special bids for neighborhood-level maps, on the other hand, local features should only get special bids in close-up zoom levels. The factors may also include inherent importance of feature type. For example, the special bid should be infinite or maximal (e.g., the highest number that can be represented in the bidding system) or nearly-maximal for preserving the name of large metropolises on a state-scale map, but fairly low for a creek name on a city-scale map. In addition, the volume of search queries that are associated with the label may be a factor in assigning special bids. This factor indicates the level of user interest (e.g., potential or actual viewers of the map) in a map entity. For example, while the Watergate Hotel is about the same size on the map as a local motel in Washington, D.C., the query volume will indicate that people are much more likely to be interested in the former, thus requiring higher special bids for the “Watergate Hotel” label than for a local motel nearby on the same map.

The provider may also place special bids for areas (e.g., areas within ground-truth labels) to prevent the occlusion of useful non-label information, based on how important the area is. For example, covering part of a long road whose name is still rendered should not require as high of a minimum bid from an advertiser as ads covering an intersection or a street name. This can also be extended to special bids on completely empty areas which, if filled with ads, could impose a cognitive load on the user—e.g. the space between two text labels that, if filled with a text ad, can appear like a single continuous line of text, obscuring the label/ad boundaries

In some implementations, in addition to the provider and advertiser, third parties serving maps (e.g., using APIs) may also have specific interest in certain features of the map being displayed at certain zoom levels. In one implementation, the third party, similar to the provider and advertiser, may submit bids for certain map features (e.g., in addition to the provider special bids). This may be done, for example, where a third party is interested in displaying some map features (e.g., ground truth labels) in areas where they would not necessarily be displayed or have high priority based purely on provider criteria (e.g., displaying a feature at more zoomed-out levels than they otherwise would).

For example, a restaurant owner may serve a map to customers, for example, on the restaurant's website, (e.g., actual or potential customers) and may bid up on the name of the street where the restaurant is to have it appear even at a multi-city zoom level, where it otherwise would not be displayed. In some implementations, a third party could pay a fee external to the auction structure to be allowed to move certain map features into a separate “maximally vital” category, guaranteed to be displayed or having a higher likelihood of being displayed on the map before the remaining space gets auctioned away between other ground truth labels and ads. In one or more implementations, third party users may pay a fee external to the auction structure to prevent any ads at all from being displayed in a particular geographical region (as specified, e.g., by a rectangle), or anywhere on the map or to adjust the level of ad presence within the map in the particular region or anywhere on the map (e.g., at specific zoom levels).

In some implementations, the third party user can request a level of ad presence to cover provider costs for providing map data in response to the third party requests. In one example, the level of ad presence defines one or more constraint on the ads desired within the requested map, including total number of ads on the map (e.g., the entire requested region or certain regions within the requested region), total value of ads within the map (e.g., the entire requested region or certain regions within the requested region), or geometric constraints on allowed or disallowed ad positions. In one or more implementations, the third party may pay partially (e.g., less money than the provider may pay for an ad-free map) to receive a map with certain map features guaranteed to be present, or a certain level of ad-freeness. The third party user may also request a map with a higher level of ad presence (e.g. lower “special bids”, or more ad slots available per viewport), and be offered, as part of the contract, a revenue-sharing agreement to share a fraction of the ad revenue from showing the ads on the third party served maps.

In one example, bids placed by third party map servers and/or advertisers and special bids placed by a provider may be run in the same auction. In some implementations, an auction for any particular map area can be run in rounds. For instance, “vital” map content such as ground truth labels (e.g., based on provider criteria or third party server preferences or bids) can be chosen in a first auction round. In the first round the competition may be only between the ground-truth labels which the map provider believes must not be omitted unless necessary to make room for another such ground-truth label. Furthermore, where a third party server has requested a map, and indicated vital map features, the vital map features may also be included within a first round of the auction.

Once vital map features are selected in primary rounds, the provider can remove any bidding for those items, including ground truth labels or areas (e.g., the provider can make infinite or maximal bids for all the areas used up in the first round or may remove those areas from bidding). A second round of bidding may then proceed including low-priority map features (e.g., creek names, business names, and any other map features such as ground truth labels not used in the first round or of interest to a third party map server) as well as ads. In the presence of more fine-grained requirements about map feature and ad priorities, an auction with three or more rounds may be conducted.

In addition to traditional 2-D maps, the methods described herein may apply to various other visual representations of geography to a user engaged in a geographically-relevant interaction. For example, a user driving with GPS navigation can be shown ads in blank parts of the GPS simulated live view. Similarly, ads may be displayed in blank/irrelevant areas in a three dimensional map or street view (e.g., the sky, the pavement, blank walls, or photos of actual billboards may display ads).

In addition to the criteria described above, the bidding process may incorporate other bidding techniques when performing the multi-level and/or multi-party bidding process. For example, bidding (e.g., by the advertiser, third party or provider) may be based on user demographics, user models, the third-party site on which the map is appearing, or the category of the site or other similar criteria which may determine the desirability of content (e.g., map features such as ground truth labels and/or ads) being displayed within a map. In some embodiments, a user will only receive the benefits of the techniques described herein if the user installs a relevant application and/or makes a selection of a related service with respect to his or her account. Furthermore, ad quality may be a factor in the bidding process. Several features can be used to predict click-through rates. These can include both observed behavior on the ad itself, as well as, for new ads, features like cognitive load (e.g. amount of text/complexity of graphics, if any), textual features (e.g., families of terms known to cause higher or lower click through rates). Where a map is shown in connection with a specific search query or other signal of user interest in a specific term or phrase, features similar to traditional sponsored search systems may also be incorporated into the bidding process. Features similar to traditional ad auctions may also be incorporated into the bidding process.

Once the bidding process is completed, the map region may be rendered including content (e.g., map features or ads) with the highest bids for the map region. In one example, when rendering the ad overlay, typographic distinction (e.g. by allocating certain colors to which the ad creative material is limited, and which are guaranteed to not be used by the map's ground-truth features) between map features and commercially-placed data may be present to maintain the usability and integrity of the map.

Once ads are displayed within the map, various analytics data about ad impressions, clicks, and other user behaviors, may be collected by the provider (or other party) and exposed to the advertiser to better inform advertising decisions. Using the methods described herein, in addition to traditional analytics, new analytics may be possible including what ads on what zoom level and/or map viewport tends to lead to the most clicks.

II. Example Client-Server Network Environments for Facilitating Auctioning of In-Map Ad Placement

FIG. 1 illustrates an example client-server network environment which provides for auctioning space in maps for the display of map features as well as commercial data. A network environment 100 includes a number of electronic devices 102, 104 and 106 communicably connected to a server 110 by a network 108. One or more remote servers 120 are further coupled to the server 110 and/or the one or more electronic devices 102, 104 and 106. Server 110 includes a processing device 112 and a data store 114. Processing device 112 executes computer instructions stored in data store 114, for example, to assist in auctioning space in maps for the display of map features as well as commercial data on maps provided for display to one or more users interacting with electronic devices 102, 104 and 106.

In some example embodiments, electronic devices 102, 104 and 106 can be computing devices such as laptop or desktop computers, smartphones, PDAs, portable media players, tablet computers, televisions or other displays with one or more processors coupled thereto or embedded therein, or other appropriate computing devices that can be used to for displaying a web page or web application. In one example, the electronic devices 102, 104 and 106 store a User agent such as a browser or application. In the example of FIG. 1, electronic device 102 is depicted as a smartphone, electronic device 104 is depicted as a desktop computer, and electronic device 106 is depicted as a PDA.

In some example aspects, server 110 can be a single computing device such as a computer server. In other embodiments, server 110 can represent more than one computing device working together to perform the actions of a server computer (e.g., cloud computing). The server 110 may host the web server communicationally coupled to the browser at the client device (e.g., electronic devices 102, 104 or 106) via network 108. In one example, the server 110 may host a map provider configured to generate maps based on auctioning space in maps for the display of map features as well as commercial data.

Each of the one or more remote servers 120 can be a single computing device such as a computer server or can represent more than one computing device working together to perform the actions of a server computer (e.g., cloud computing). Each of the one or more remote servers 120 may host an advertiser wishing to place advertisements within maps being generated by the provider hosted at server 110 or a third party server requesting maps from the provider at server 110. In one embodiment server 110 and one or more remote servers 120 may be implemented as a single server. In one example, the server 110 and one or more remote servers 120 may communicate through the user agent at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

III. Example Processes for Facilitating Auctioning of In-Map Ad Placement

FIG. 2 illustrates a flow diagram of an example process 200 for generating a map region based on an auction for content to be displayed within the map. The content displayed within the map may include map features (e.g., map content including ground truth-labels) as well as commercial data such as advertisements.

In block 201, the system identifies a region on a map. In one example, the region may be selected by the provider and may comprise a portion of an entire map being provided for display to a user. In one example, the region of the map may comprise a portion of a map being provided in response to a request (e.g., a search query by a user, or a selection by a third party server, advertiser or provider). The map region may define at a specific zoom level.

In block 202, one or more special bids for map content to be displayed on the region of the map are determined. The special bids are placed by the provider on map content associated with the region of the map. The map content includes areas, as well as ground truth labels that should be displayed on the map region. Ground truth labels may include labels for map items located on a map including one or more of countries, states, cities, districts, counties, administrative regions, streets, rivers, attractions, businesses, elevation lines or landmarks. The special bids may be placed for specific map features, including areas and/or labels within the region (e.g., at the specific zoom level). FIG. 4, described in more detail below, illustrates an example user interface that may be displayed to a provider to facilitate placing special bids on map features.

When placing special bids, the Provider can bid maximally high for certain types of features to prevent advertising from covering them. The maps area or content may be organic map content needed to preserve “ground truth” labels that come from objective map features. Ground truth labels may include street names, city names, county names, state names, country names, river names, mountain names, business names, names of geographic or cultural landmarks or other labels, for map content. Ground truth labels may also include elevation lines, and other geographical indicators being displayed within the map.

The provider may also place special bid for areas (e.g., areas within ground-truth labels) to prevent the occlusion of useful non-label information, based on how important the area is. For example, covering part of a long road whose name is still rendered should not require as high of a minimum bid from an advertiser as ads covering an intersection or a street name. This can also be extended to special bids on completely empty areas which, if filled with ads, could impose a cognitive load on the user—e.g. the space between two text labels that, if filled with a text ad, can appear like a single continuous line of text, obscuring the label/ad boundaries.

The special bids placed by the provider for map features within a map region may be based on a number of factors. These factors may be similar to factors used to decide whether to show a label in dynamic map. Such factors may include zoom level, inherent importance of feature type and/or the volume of search queries that associated with the feature.

In block 203, one or more bids from one or more advertisers and/or third party servers for the identified region are determined.

In one implementation, advertisers can bid on placing an ad (text or visual) somewhere within the map region. FIG. 5, described in more detail below, illustrates an example user interface that may be displayed to an advertiser to facilitate placing bids for displaying an ad within a map region.

Third parties serving maps (e.g., using APIs) may also have specific interest in certain features of the map being displayed with the map region (e.g., at certain zoom levels). In one implementation, the third party, similar to the provider and advertiser, may submit bids for some ground truth labels and/or areas in addition to the provider “special bids”. This may be done, for example, where a third party is interested in displaying some features in areas where they would no necessarily be displayed or have high priority (e.g., displaying a feature at more zoomed-out levels than they otherwise would). FIG. 4, described in more detail below, illustrates an example user interface that may be displayed to a third party server to facilitate placing bids on map features.

In block 204, the system selects one or more contents to be displayed on the map region based on the special bids determined in block 202 and/or the bids determined in block 203. The one or more contents may include map features and/or commercial content (e.g., ads) selected based on bids placed for the map features and commercial content within the map region (e.g., defined as a portion of the map at a certain zoom level).

In one example, bids placed by third party map servers and/or advertisers and special bids placed by a provider may be entered into the same auction and the one or more contents may be selected according to the auctioning of the bids to select the highest valued bids (e.g., monetarily or based on the importance or benefit of the content). The value of bids may be determined, for example, based on one or more of ad bids, ad predicted click-through rates, expected revenue from the ad, estimated importance or benefit of the content, or some combination thereof.

In some implementations, an auction for any particular map area can be run in rounds. For instance, “vital” ground truth labels (e.g., based on provider criteria or third party server preferences or bids) can be chosen in a first auction round. In the first round the competition may be only between the ground truth labels which the map provider believes must not be omitted unless necessary to make room for another such ground truth label.

In some implementations, a third party could pay a fee external to the auction structure to be allowed to move certain map features into a separate “maximally vital” category, guaranteed to be displayed on the map before the remaining space gets auctioned away between other ground truth labels and ads. Where a third party server has requested a map, and indicated maximally vital map features, the maximally vital map features may also be included within the first round of the auction.

Once the map features are selected in the first round, the provider can remove any bidding for those map features (e.g., the provider can make infinite or maximal bids for all the areas used up in the first round or may remove those areas from bidding). A second round of bidding may then proceed including low-priority ground truth labels (e.g., creek names and business names and any other ground truth labels not used in the first round or of interest to a third party map server) as well as ads. In the presence of more fine-grained requirements about label and ad priorities, an auction with three or more rounds may be conducted.

In addition to the criteria described above, the bidding process may incorporate other bidding techniques when performing the multi-level and/or multi-party bidding process. For example, bidding (e.g., by the advertiser, third party or provider) may be based on user demographics, user models, the third-party site on which the map is appearing, or the category of the site or other similar criteria which may determine the desirability of content (e.g., map content such as ground truth labels and/or ads) being displayed within a map. Furthermore, ad quality may be a factor in the bidding process. Several features can be used to predict click-through rates. These can include both observed behavior on the ad itself, as well as, for new ads, features like cognitive load (e.g. amount of text/complexity of graphics, if any), textual features (e.g., families of terms known to cause higher or lower click through rates). Where a map is shown in connection with a specific search query or other signal of user interest in a specific term or phrase, features similar to traditional sponsored search systems may also be incorporated into the bidding process.

In block 205, the region on the map is rendered including the one or more selected content. In one example, once the bidding process is completed, the map will be rendered including content (e.g., map content such as ground truth labels or map areas and/or ads) with the highest bids for each map region. In one example, when rendering the ad overlay, typographic distinction (e.g. by allocating certain colors to which the ad creative material is limited, and which are guaranteed to not be used by the map's ground-truth features) between ground-truth map features and commercially-placed data may be present to maintain the usability and integrity of the map.

In block 206, the rendered region of the map is provided for display to one or more users. In one example, the third party server causes the user's client to request from the provider a specified map region, in response to which the provider provides the user's client with the requested map region as rendered with zero or more ads, for example based on the determined level of ad presence.

FIG. 3 illustrates a flow diagram of an example process 300 for providing a map to a third party. In block 301, a request to serve a map to a third party is received by a provider. In block 302, the provider determines the level of ad presence associated with the request. In some implementations, the third party user can request a level of ad presence to cover provider costs for providing map features in response to the third party requests. In one or more implementations, the third party may pay partially (e.g., less than for an ad-free map) to receive the service of a map with certain features guaranteed to be present, or a certain level of ad-freeness.

In one or more implementations, third party users may pay a fee for a lower level of ad presence that constrains the volume of ads being displayed or provides geometric constraints on allowed or disallowed ad positions in a particular geographical region (as specified, e.g., by a rectangle at a specific zoom level), or anywhere on the map. The third party user may also request a map with a higher level of ad presence (e.g. lower “special bids”, or more ad slots available per viewport), and be offered, as part of the contract, a revenue-sharing agreement to share a fraction of the ad revenue from showing the ads on the third party served maps.

In block 303, the provider generates a map according to the level of ad presence. In one example, the map is generated according to the process 200 described in more detail with respect to FIG. 2. In one example, the map content selection in process 200 is performed by taking into account the level of ad presence indicated by the provider, such that the auction process takes into account the number or level of ads the third party server wishes to have included in the map.

In block 304, the map is provided to the third party server in response to the request.

FIG. 4 illustrates an example user interface 400 provided for display to a provider or third party server to facilitate placing bids on map features. The graphical user interface 400 includes a map selection area 401 for selecting a region of a map, and a bidding table 402 for entering bids for various map features at various zoom levels for the select map region. A provider or third party server may select a region of a map (indicated by the dotted lines 403 displayed in the map selection area 401). Next, the provider or third party server may enter bids for various map features (e.g., ground truth labels or areas) to be displayed within the map at various zoom levels by entering bids within the entry fields of the bidding table 402. It should be noted that a provider or third party server does not need to indicate a bid for each field of the table, and may only enter bids for desired map features at specific zoom levels by entering the bid in the entry field referring to the map feature at the specific zoom level.

FIG. 5 illustrates an example user interface 500 provided for display to an advertiser to facilitate placing bids for displaying an ad within a map region. The graphical user interface 500 includes a map selection area 501 for selecting a region of a map, an ad selection area 502 for uploading an ad and a bidding table 503 for entering bids for displaying the ad within the selected map region at various zoom levels. An advertiser may select a region of a map (indicated by the dotted lines 504 displayed in the map selection area 501) where the advertiser wishes to display a map (e.g., a region of a map including a business or other entity relating to the ad). Next, the advertiser may upload the ad 505 into the ad selection area or may generate an ad using a local application at the ad selection area. The advertiser can then bids for displaying the ad within the map region at various zoom levels by entering bids within the entry fields of the bidding table 503. It should be noted that the advertiser does not need to indicate a bid for each field of the table, and may only enter bids for desired zoom levels by entering the bid in the entry field referring to the ad at the specific zoom level.

IV. Example System for Facilitating Auctioning of In-Map Ad Placement

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

FIG. 6 conceptually illustrates an electronic system with which some implementations of the subject technology are implemented. Electronic system 600 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 600 includes a bus 608, processing unit(s) 612, a system memory 604, a read-only memory (ROM) 610, a permanent storage device 602, an input device interface 614, an output device interface 606, and a network interface 616.

Bus 608 collectively represents all system, peripheral, and chipset buses that communicatively connect the numerous internal devices of electronic system 600. For instance, bus 608 communicatively connects processing unit(s) 612 with ROM 610, system memory 604, and permanent storage device 602.

From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. Some implementations of the subject disclosure use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such a random access memory. System memory 604 stores some of the instructions and data that the processor needs at runtime. In some implementations, the processes of the subject disclosure are stored in system memory 604, permanent storage device 602, and/or ROM 610. For example, the various memory units include instructions for facilitating auctioning space in maps for the display of map features as well as commercial data according to various embodiments. From these various memory units, processing unit(s) 612 retrieves instructions to execute and data to process in order to execute the processes of some implementations.

Bus 608 also connects to input and output device interfaces 614 and 606. Input device interface 614 enables the user to communicate information and select commands to the electronic system. Input devices used with input device interface 614 include, for example, alphanumeric keyboards and pointing devices (also called “cursor control devices”). Output device interfaces 606 enables, for example, the display of images generated by the electronic system 600. Output devices used with output device interface 606 include, for example, printers and display devices, such as cathode ray tubes (CRT) or liquid crystal displays (LCD). Some implementations include devices such as a touchscreen that functions as both input and output devices.

Finally, as shown in FIG. 6, bus 608 also couples electronic system 600 to a network (not shown) through a network interface 616. In this manner, the computer can be a part of a network of computers (such as a local area network (“LAN”), a wide area network (“WAN”), or an Intranet, or a network of networks, such as the Internet. Any or all components of electronic system 600 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of blocks in the processes disclosed is an illustration of exemplary approaches. Based upon design preferences, it is understood that the specific order or hierarchy of blocks in the processes may be rearranged, or that some illustrated blocks may not be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure. Features under one heading may be combined with features under one or more other heading and all features under one heading need not be use together. Features under one heading may be combined with features under one or more other heading and all features under one heading need not be use together.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for multi-party auctioning of map content, the method comprising:
identifying, using one or more computing devices, a first region on a map;
determining, using the one or more computing devices, one or more special bids for one or more map features associated with a location within the first region;
determining, using the one or more computing devices, one or more bids for one or more contents to be placed on the first region, the one or more contents comprising one or more of one or more advertisements or one or more map features;
selecting, using the one or more computing devices, a set of content to be displayed on the first region of the map based at least in part on the one or more special bids and one or more bids, the set of content including one or more of one or more advertisements or one or more map features; and
rendering, using the one or more computing devices, the first region of the map including the set of content.

2. The method of claim 1, further comprising:
providing, using the one or more computing devices, the rendered first region for display.

3. The method of claim 1, wherein the one or more special bids comprise bids received from a provider of the map data.

4. The method of claim 1, wherein the one or more bids are received from one or more of a provider of the map data, advertisers or third parties serving the map.

5. The method of claim 1, wherein the blocks of receiving one or more special bids comprises:
identifying one or more vital map features; and
placing a special bid for each of the one or more vital map features, wherein a special bid is a high value such that the map features has a high probability of being selected during the selecting process.

6. The method of claim 5, wherein the selecting the set of content comprises:
selecting one or more vital map features based on one or more of the special bids for the one or more map features or a bid of the one or more bids for a map feature;
identifying one or more qualifying content of the one or more contents, the one or more qualifying content not being placed at a position of the one or more vital map features; and
selecting at least one of the one or more qualifying content as an item of the set of items based on the one or more bids.

7. The method of claim 1, further comprising:
receiving a request for the map from the third party serving the map;
determining a level of ad presence associated with the request, wherein the level of ad presence is defined in terms of one or more of number of ads, total value of ads, or geometric constraints on allowed or disallowed ad positions on the map; and
selecting the set of items further based on the level of ad presence.

8. The method of claim 7, wherein the level of ad presence is dependent upon one or more of the portion of a cost of providing the map the third party wishes to cover or the portion of revenue from advertisement the third party wishes to share with the provider.

9. The method of claim 1, wherein determining the special bids and the one or more bids comprises:
determining a zoom level associated with the first region; and
identifying one or more special bids and one or more bids for content to be placed within the first map region at the zoom level.

10. The method of claim 1, wherein the map features comprise ground truth labels or areas within the map.

11. The method of claim 1, wherein the ground truth labels include labels for map items located within the region including one or more of countries, states, cities, districts, counties, administrative regions, streets, rivers, attractions, businesses, elevation lines or landmarks.

12. The method of claim 1, wherein the first map region is defined as a portion of a map at a specific map zoom level, such that the set of content are displayed on the map at the specific map zoom level.

13. A system for multi-party auctioning of map content, the system comprising:
one or more processors; and
a machine-readable medium comprising instructions stored therein, which when executed by the processors, cause the processors to perform operations comprising:
identifying a first region on a map, the first region of the map corresponding to an area within a map being displayed at a first zoom level;
determining one or more special bids for one or more map features being located within the first region of the map;
determining one or more bids for one or more commercial contents to be displayed on the first region;
selecting one or more contents for display within the first region of the map based at least in part on the one or more special bids and one or more bids, the one or more contents including one or more of map features or commercial content; and
rendering, using the one or more computing devices, the first region of the map including the one or more contents.

14. The system of claim 13, wherein the one or more special bids comprise bids by a provider of the map, the special bids reflecting the importance of each of the one or more map features being displayed within the first region of the map.

15. The system of claim 13, wherein selecting the one or more contents comprises:
for each displayable portion of the first region, determining based on the one or more bids and the one or more special bids, one of a one or more map features or the one or more commercial contents to be displayed within the area based on the value of the special bid associated with the one of the one or more map features to be displayed within the area and the bid value for each of the potential commercial content to be displayed within the portion.

16. The system of claim 13, the operations further comprising:
determining one or more additional bids for one or more map features being located within the first region of the map from a third party server, wherein selecting the one or more contents further comprises selecting the one or more contents based on the one or more additional bids.

17. The system of claim 13, the operations further comprising:
receiving a request for the map from the third party serving the map;
determining a level of ad presence associated with the request, wherein the level of ad presence defines the number of ads that the third party wishes to view on the map and wherein the level of ad presence is dependent upon one or more of the portion of a cost of providing the map the third party wishes to cover or the portion of revenue from advertisement the third party wishes to share with the provider; and
selecting the set of items further based on the level of ad presence.

18. A machine-readable medium comprising instructions stored therein, which when executed by a machine, cause the machine to perform operations comprising:
identifying a map region, the map region being displayable at a plurality of zoom levels;
determining one or more bids for one or more map features to be displayed within the map region at one or more of the plurality of zoom levels, the value of the one or more bids for the one or more map features at each of the one or more zoom levels indicating the importance of a map feature being displayed within the map region at the zoom level;
determining one or more bids for one or more commercial contents to be displayed within the map region at one or more of the plurality of zoom levels; and
determining one or more of the map features or the one or more commercial contents to be displayed within the map region at each of the plurality of zoom levels based at least in part on the one or more bids for the one or more map features and the one or more bids for the one or more commercial contents.

19. The machine-readable medium of claim 18, the operations further comprising:
receiving a request to provide the map region for display to a user at a zoom level of the plurality of zoom levels;
identifying the one or more of the map features or the one or more of the commercial content to be displayed within the map region at the zoom level based at least in part on the one or more bids for the one or more map features and the one or more bids for the one or more commercial contents; and
rendering the map region at the zoom level including the one or more of the map features or the one or more of the commercial content to be displayed within the map region at the zoom level.

20. The machine-readable medium of claim 18, wherein the one or more bids for the one or more map features and the one or more bids for the one or more commercial contents is provided by one or more of a provider, a third-party server or an advertiser.
